(19) United States
(12) Patent Application Publication
(10) Pub. No.: US 2007/0058893 A1
(43) Pub. Date: Mar. 15, 2007

(54) Printing press bearing

(75) Inventor: Stephan Patzelt, Plauen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/520,907

(22) Filed: Sep. 14, 2006

(30) Foreign Application Priority Data
Sep. 14, 2005 (DE) 10 2005 043 773.7

(51) Int. Cl. F16C 19/00

(52) U.S. Cl. 384/448; 384/446

(57) ABSTRACT

A printing press bearing includes a radio frequency identification device, especially an active RFID read/write device, wherein in a first operating mode, namely, in a receiving mode, the RFID device receives and stores bearing data, and wherein in a second operating mode, namely, in a transmitting mode, the RFID device transmits the data that was read in and stored in the first operating mode.

### BACKGROUND OF THE INVENTION

1. Field of the Invention

The present invention relates to a bearing, and more specifically to a printing press bearing.

2. Description of the Related Art

The bearings of printing presses are highly stressed parts whose state of wear, service life, and maintenance depend on the conditions under which the bearings are operated. For example, vibratory stresses, radial forces acting on the bearings, bearing temperatures, and bearing overrollings affect the maintenance intervals of the bearings and the state of wear and thus the service life. Known prior-art bearings do not provide information about their state of wear. Therefore, bearings are usually serviced or even changed on a routine basis at prescribed intervals, so that the bearings are then serviced or changed either too early or too late. If the bearings are serviced or changed too early, this means that they could have been operated for a longer period of time according to their state of wear, which results in increased costs. If the bearings are serviced or changed too late, this means that defects can result in unscheduled shutdowns of the press, and this results in production losses and cost disadvantages.

### SUMMARY OF THE INVENTION

The object of the present invention is to provide a new type of bearing which solves the problems of the prior art. The object is achieved by a bearing including a radio frequency identification device, especially an active RFID read/write device, which operates in a receiving mode and a transmitting mode, the RFID device receiving and storing bearing data in the receiving mode and transmitting the stored data in the transmitting mode.

The present invention proposes a bearing that contains an RFID device. In a first operating mode, the RFID device receives and stores bearing data. In a second operating mode, the RFID device transmits the stored bearing data. The present invention further proposes a bearing in which bearing data about the bearing load and thus the state of wear of the bearing can be automatically stored in the RFID device and read out. This allows exact monitoring of bearing load states and states of wear, so that bearings can be serviced or changed at the proper time, depending on their state of wear. This results in cost advantages.

For this purpose, the use of an active RFID device is preferred. However, it is also possible to use a passive RFID to interrogate for instantaneous operating parameters, i.e., an RFID which takes the energy required for determining and transmitting the data from the HF field of the interrogating reading device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a schematic block diagram representation of a bearing according to an embodiment of the present invention.

### DETAILED DESCRIPTION OF THE PRESENTLY PREFERRED EMBODIMENTS

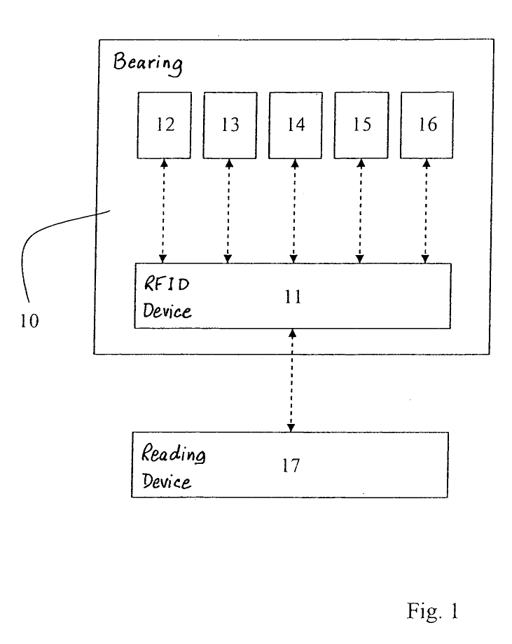

FIG. 1 is a schematic block diagram of a bearing 10 of a printing press according to an embodiment of the present invention, wherein the bearing 10 contains a radio frequency identification (RFID) device 11. The RFID device 11 is designed here as an active RFID device that has its own voltage supply or power supply in the form of a battery. This RFID device 11 can both receive and store data and transmit data. The RFID device 11 may alternatively comprise a passive RFID device.

In accordance with an embodiment of the present invention, the RFID device 11 of the bearing 10 is operable in a first operating mode, in which the RFID device 11 receives bearing data measured by sensors 12, 13, 14, 15, and 16 and stores this data, and in a second operating mode, in which the RFID device 11 transmits data that was previously stored. The first operating mode is also referred to as the receiving mode, and the second operating mode is also referred to as the transmitting mode.

The bearing data received and stored in the first operating mode of the RFID device 11 may comprise the instantaneous values of bearing data. For example, in the specific embodiment illustrated in FIG. 1, the sensor 12 is a temperature sensor which supplies temperature values of the bearing. The sensor 13 is a speed sensor which supplies speed values, sensor 14 is a force sensor which supplies force values, preferably radial force values, and sensor 15 is a frequency sensor which provides frequency values of vibratory states of the bearing. These instantaneous values are transmitted by the sensors 12 to 16 and received and stored by the RFID device 11.

Besides instantaneous values of this type, summed or integrated bearing parameters related to the operation of the bearing may also be received and stored in the first operating mode. In the specific embodiment illustrated in FIG. 1, the sensor 16 measures and transmits corresponding overrolling values of the bearing 10, which are again received and stored by the RFID device 11.

According to an embodiment of the present invention, the RFID device 11 receives and stores the bearing data from the sensors 12 to 16 at regular intervals of time. Furthermore, the RFID device 11 goes into the first operating mode as a function of the operating state of the bearing, especially as a function of the operating state of a printing press in which the bearing is used, and then receives and stores the bearing data from the sensors 12 to 16.

In accordance with another embodiment of the present invention, over a certain interval of time, the RFID device 11 continuously receives and stores the bearing data measured and transmitted by the sensors 12 to 16.

Therefore, in accordance with the present invention, a bearing 10 is proposed which has an RFID device 11 for receiving and storing bearing data. The sensors 12 to 16 assigned to the bearing 10 measure the bearing data and transmit it to the RFID device 11.

A reading device 17 is connected to the RFID device 11 for reading the data stored in the RFID device 11 of the bearing 10. To this end, in the second operating mode, the RFID device 11 transmits to the reading device 17 the bearing data previously received and stored in the first operating mode. The transmission by the RFID device 11 of the bearing data stored in the RFID device 11 may, for example, be initiated by the reading device 17.

During the periods of time in which the RFID device 11 is being used neither to receive and store bearing data in the first operating mode nor to transmit bearing data in the second operating mode, it is preferably in a resting mode to save energy.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A bearing device with a radio frequency identification device, said bearing device being operable in a first operating mode and a second operating mode, wherein the first operating mode is a receiving mode in which said radio frequency identification device receives and stores bearing data and the second operating mode is a transmitting mode in which said radio frequency identification device tranmits the data that was read in and stored during the first operating mode.

2. The bearing device of claim 1, wherein said radio frequency identification device receives, in said first operating mode, instantaneous values of bearing parameters comprising at least one of a temperature value, a speed value, a force value, and a frequency value.

3. The bearing device of claim 1, wherein said radio frequency identification device receives, in said first operating mode, summed or integrated bearing parameters related to the operation of the bearing including overrolling values.

4. The bearing device of claim 1, wherein said radio frequency identification device enters the first operating mode as a function of the operating state of the bearing.

5. The bearing device of claim 1, wherein said radio frequency identification device enters the first operating mode at predetermined time intervals and then receives and stores the bearing data.

6. The bearing of claim 1, further comprising sensors which measure the bearing data and transmit it to the RFID device.

7. The bearing of claim 1, wherein the radio frequency identification device is an active radio frequency identification read/write device,

8. The bearing device of claim 4, wherein said bearing device is a printing press bearing, and said radio frequency identification device enters the first operating mode as a function of the operating state of the printing press.

9. The bearing device of claim 1, wherein said bearing device is a printing press bearing.
